(19) United States
(12) Patent Application Publication
(10) Pub. No.: US 2026/0320533 A1
(43) Pub. Date: Oct. 15, 2026

(54) SYSTEM CONTROLLER FOR GENERATING AND FORWARDING EMISSIONS REPORTS TO CUSTOMER

(71) Applicant: Applied Materials, Inc., Santa Clara, CA (US)

(72) Inventors: Ju Hyung LEE, Santa Clara, CA (US); Sushim KOSHTI, Portland, OR (US); Venugopal VELLANKI, Santa Clara, CA (US); Nasreen CHOPRA, Santa Clara, CA (US); Shaun W. CRAWFORD, Santa Clara, CA (US); Maxime CAYER, Chandler, AZ (US); Benjamin GROSS, Santa Clara, CA (US)

(21) Appl. No.: 19/642,953

(22) Filed: Apr. 9, 2026

Related U.S. Application Data
(60) Provisional application No. 63/786,893, filed on Apr. 10, 2025.

(51) Int. Cl. G06Q 10/0639

(52) U.S. Cl. CPC G06Q 10/06393

(57) ABSTRACT

Aspects generally relate to systems and methods including receiving, by a system controller from a plurality of processing components, process data associated with operation of one or more semiconductor processing tools and an abatement system coupled to the one or more semiconductor processing tools, determining, by the system controller from the process data, direct greenhouse-gas emissions associated with the operation of the one or more semiconductor processing tools using measured or monitored operating data of the processing environment, generating, by the system controller, a report satisfying direct greenhouse-gas emissions reporting requirements based on the determined direct greenhouse-gas emissions, and transmitting, by the system controller over a network, the report to a remote user system associated with operation of the one or more semiconductor processing tools.

### CROSS-REFERENCE TO RELATED APPLICATIONS

This application claims benefit of United States provisional patent application Ser. No. 63/786,893, filed Apr. 10, 2025, which is herein incorporated by reference in its entirety.

### BACKGROUND

### Field

Aspects generally relate to methods and systems for reporting Scope 1 emissions directly to users.

### Description of the Related Art

In semiconductor manufacturing, chemical processing, and electronics fabrication, abatement systems are used to mitigate environmental impacts associated with process gases used and generated during production. Exhaust streams from semiconductor processing chambers typically include a mixture of unreacted process gases, partially reacted gases, and byproducts generated during processing. Abatement systems, such as plasma-based abatement systems, combustion-based abatement systems, thermal oxidation systems, wet scrubbers, dry scrubbers, or combinations thereof, are employed to treat these exhaust gases prior to release.

Combustion-based abatement systems may generate carbon dioxide (CO₂) and water vapor (H₂O) through oxidation of fuel gases, such as natural gas or other hydrocarbons (e.g., CH₄+O₂→CO₂+H₂O), while plasma-based, combustion-based and other abatement systems may produce residual greenhouse gases and reaction byproducts depending on process conditions and gas composition. In addition, both plasma-based and combustion-based abatement systems may generate nitrogen oxides (NOₓ) and other byproducts because of high-temperature or plasma-assisted reactions.

Scope 1 greenhouse gas emissions in semiconductor manufacturing may include CO₂, residual process gases such as perfluorocarbons (PFCs), nitrogen trifluoride (NF₃), sulfur hexafluoride (SF₆), methane (CH₄), and other high-global-warming-potential gases associated with etch, deposition, and chamber-clean processes. These emissions are classified as Scope 1 emissions under the Greenhouse Gas Protocol, representing direct emissions from processes owned or controlled by an organization.

Managing and reporting Scope 1 emissions has become a priority for organizations seeking to comply with increasingly stringent environmental regulations and align with global sustainability initiatives. However, accurately quantifying emissions from semiconductor processing environments presents technical challenges due to variations in process gas composition, chamber operating conditions, abatement system type, and abatement efficiency. Prior monitoring and reporting approaches rely on facility-level estimates, periodic manual data collection, or generalized emissions factors, which may lack the precision and scalability needed to provide reliable, near real-time emissions data to downstream users. Accordingly, improved systems and methods are needed to accurately measure, analyze, and report emissions associated with semiconductor processing tools and associated abatement systems, enabling organizations to meet regulatory requirements, improve transparency, and support sustainability objectives.

### SUMMARY

Aspects generally relate to methods and systems for reporting Scope 1 emissions directly to users.

In one implementation, a method includes receiving, by a system controller from a plurality of processing components, process data associated with operation of one or more semiconductor processing tools and an abatement system coupled to the one or more semiconductor processing tools, determining, by the system controller from the process data, direct greenhouse-gas emissions associated with the operation of the one or more semiconductor processing tools using measured or monitored operating data of the processing environment, generating, by the system controller, a report satisfying direct greenhouse-gas emissions reporting requirements based on the determined direct greenhouse-gas emissions, and transmitting, by the system controller over a network, the report to a remote user system associated with operation of the one or more semiconductor processing tools.

In one implementation, a system includes an abatement system configured to receive exhaust from one or more semiconductor processing tools, a communication interface configured to receive process data associated with the one or more semiconductor processing tools and the abatement system, and a system controller comprising one or more processors and a memory storing instructions that, when executed by the one or more processors, cause the system controller to receive the process data from the communication interface, determine direct greenhouse-gas emissions associated with operation of the one or more semiconductor processing tools and the abatement system using measured or monitored operating data, generate a report satisfying direct greenhouse-gas emissions reporting requirements based on the determined direct greenhouse-gas emissions, and transmit the report to a remote user system.

In one implementation, a method includes receiving, by a system controller, process data associated with operation of one or more semiconductor processing tools and an abatement system coupled to the one or more semiconductor processing tools, determining, by the system controller from the process data, direct greenhouse-gas emissions associated with operation of the one or more semiconductor processing tools and the abatement system, evaluating, by the system controller, the determined direct greenhouse-gas emissions, predicted direct greenhouse-gas emissions, or abatement efficiency relative to one or more thresholds, determining, by the system controller, a control action based on the evaluating, and causing, by the system controller, adjustment of one or more operating parameters of the one or more semiconductor processing tools or the abatement system based on the control action. Causing adjustment of the one or more operating parameters comprises transmitting a control instruction to the one or more semiconductor processing tools or the abatement system and thereafter monitoring updated operation to determine updated direct greenhouse-gas emissions.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1A is a block diagram of a system controller providing Scope 1 emissions reports directly to a user network, according to one implementation.

FIG. 1B is a block diagram of an emissions-data acquisition, processing, storage, and reporting architecture including semiconductor processing tools, a sensor layer, an abatement system, a system controller, local and remote data storage, and a user/customer reporting layer, according to one implementation.

FIG. 2 is a flowchart of a method for identifying and tracking Scope 1 emissions, according to one implementation.

FIG. 3 is a flowchart of a method for reporting Scope 1 emissions directly to the user, according to one implementation.

FIG. 4 is a flowchart of a closed-loop emissions control method in which a system controller determines emissions information from tool and abatement data, evaluates one or more control criteria, and selectively adjusts one or more operating parameters of semiconductor processing tools and/or an abatement system, according to one implementation.

FIG. 5 is a method for controlling emissions reporting in a processing environment, according to one implementation.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Aspects generally relate to methods and systems for reporting Scope 1 emissions to users.

The evolving landscape of environmental accountability demands more precise and actionable data to address greenhouse gas emissions. Traditional approaches to emissions reporting often have users calculate and report Scope 1 emissions based on aggregate data or generalized estimates provided by suppliers, a methodology referred to as a top-down approach. While this method offers a high-level view of emissions, it frequently lacks granularity and accuracy, leading to inconsistencies and challenges in meeting regulatory and sustainability goals. A shift toward a bottom-up approach, where suppliers directly report determined or calculated Scope 1 emissions from processes such point-of-use (POU) abatement systems, including plasma-based abatement, combustion-based abatement, thermal oxidation abatement, catalytic abatement, wet scrubbers, dry scrubbers, or combinations thereof, to the user, represent an alternative approach in emissions accountability.

In one example, abatement systems, such as plasma-based abatement systems, combustion-based abatement systems, thermal oxidation systems, wet scrubbers, dry scrubbers, or combinations thereof are used in semiconductor manufacturing to reduce the environmental impact of process gases used and generated during semiconductor processing. These systems efficiently treat greenhouse gases including perfluorocarbons (PFCs), nitrogen trifluoride (NF₃), sulfur hexafluoride (SF₆), methane (CH₄), and other process gases prior to release.

Combustion-based abatement systems may generate carbon dioxide (CO₂) because of oxidation of fuel gases, such as natural gas or other hydrocarbons, used during the combustion process. In contrast, plasma-based abatement systems do not rely on fuel combustion and therefore may generate carbon dioxide primarily through decomposition of processed gases or formation of reaction byproducts. Additionally, both plasma-based and combustion-based abatement systems may generate nitrogen oxides (NOₓ) and other reaction byproducts depending on operating conditions, where nitrogen oxides are typically regulated as hazardous air pollutants rather than greenhouse gases.

Scope 1 greenhouse gas emissions and semiconductor manufacturing may include carbon dioxide, residual process gases, high global warming potential gases, and other gases used in etch, deposition, and chamber clean processes.

Accurate quantification of these emissions is valuable for both the supplier and the user to ensure compliance with environmental standards and achieve carbon reduction targets.

By adopting a bottom-up approach, suppliers can use advanced monitoring and data collection technologies to determine Scope 1 emissions based on process and operational data associated with abatement systems. This methodology enables more precise tracking of emissions in real time, providing detailed and reliable data that can be reported directly to the user. Such transparency empowers users to integrate determined emissions data into their sustainability reports and supply chain assessments, reducing the need for users to rely on estimates or independently calculate emissions. Additionally, the bottom-up approach facilitates greater accountability by tying emissions data to specific processes, equipment, and operational conditions.

The benefits of this approach are multifaceted. For suppliers, directly reporting emissions establishes them as transparent and responsible partners, fostering stronger relationships with environmentally conscious users. It also provides an opportunity to differentiate their products and services in the marketplace. For users, the receipt of granular, determined or calculated emissions data simplifies compliance with reporting frameworks, such as the Carbon Disclosure Project (CDP) and Science-Based Targets initiative (SBTi). This data can also inform targeted reduction strategies, helping users identify and address emissions hotspots within their supply chains.

Moreover, a bottom-up reporting framework aligns with global sustainability trends, where businesses are increasingly held accountable not only for their emissions but also for those within their value chain (Scope 3 emissions). By proactively reporting Scope 1 emissions from POU abatement systems, including plasma-based abatement, combustion-based abatement, thermal oxidation systems, catalytic abatement systems, wet scrubbers, dry scrubbers, or combinations thereof, suppliers contribute to reducing the administrative burden on users and strengthen collaborative efforts to achieve net-zero goals.

The example embodiments thus present a method and system to transition from a top-down to a bottom-up approach for Scope 1 emissions reporting from POU abatement systems, including plasma-based abatement, combustion-based abatement, thermal oxidation systems, catalytic abatement systems, wet scrubbers, dry scrubbers, or combinations thereof, which represents an improvement in environmental accountability. It shifts the responsibility of emissions quantification to the supplier, who is best positioned to provide more accurate data, while delivering benefits in accuracy, transparency, and collaboration across the value chain. This example approach simplifies compliance for users. The bottom-up approach for Scope 1 emissions reporting involves identifying and tracking all process gases, categorizing the gases by semiconductor tool type and process type, calculating estimated emissions using Intergovernmental Panel on Climate Change (IPCC) Tier 2c emissions factors and determined or estimated gas flows, and automating the tracking and reporting of such Scope 1 emissions data and/or reports directly to the user in real-time, near real-time or at periodic time intervals.

Although certain examples described herein refer to specific abatement technologies, such references are provided for illustrative purposes and should not be construed as limiting. The systems and methods described herein may be applied to any abatement system configured to reduce, remove, neutralize, or otherwise process gases, greenhouse gases, or hazardous emissions generated by industrial equipment. Furthermore, the abatement system may be located at a point-of-use location, facility level location, or distributed across multiple processing locations, and may be integrated with semiconductor processing tools, exhaust handling systems, facility infrastructure, or combinations thereof. In some implementations, multiple abatement systems may be used, and the system controller may receive data from one or more upstream or downstream abatement systems. For example, exhaust gases may pass through multiple abatement stages, such as plasma abatement followed by wet scrubbing or combustion abatement followed by catalytic treatment. The systems and methods described herein may determine emissions and generate reports based on data from one or more of such abatement systems.

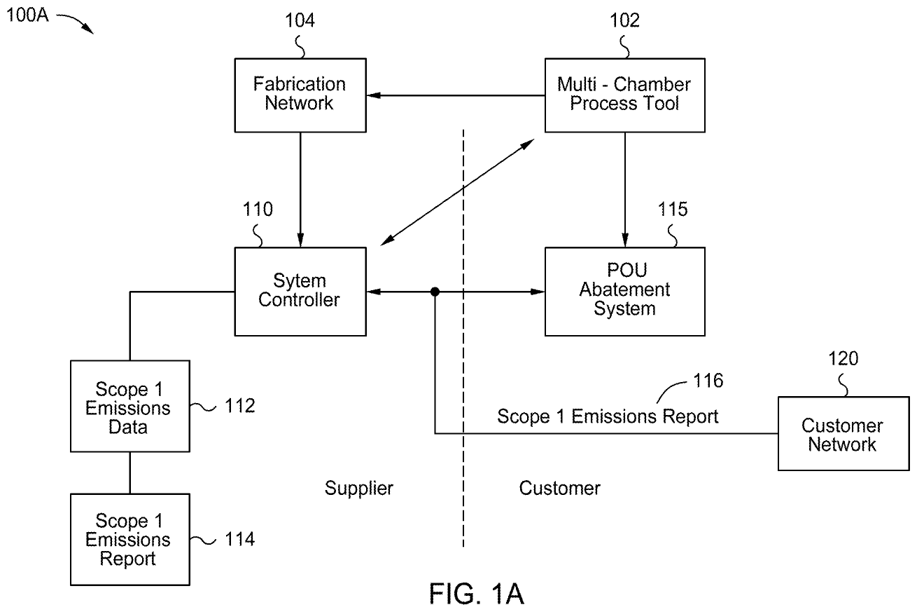

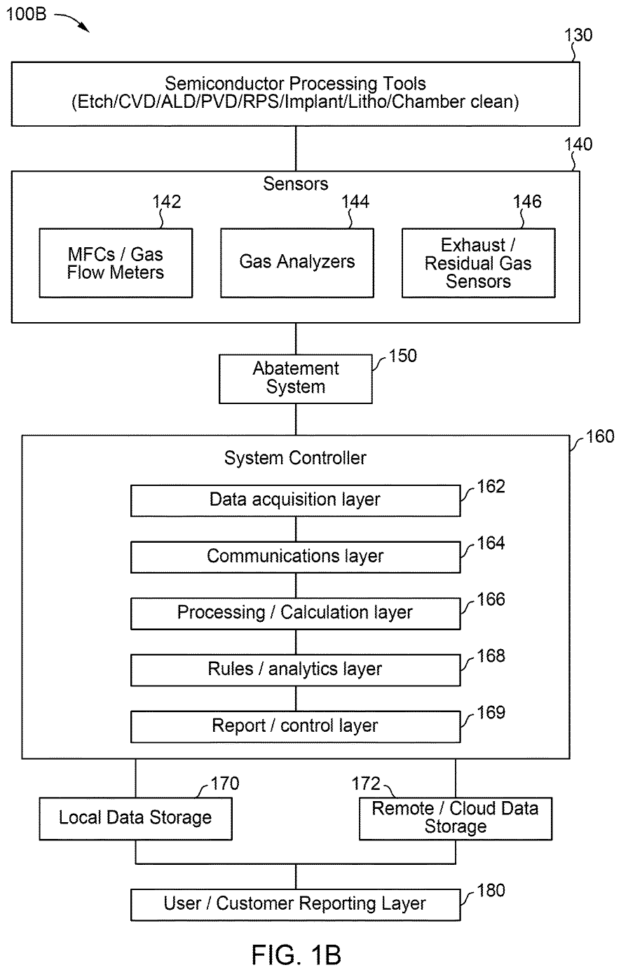

FIG. 1A is a block diagram of a system controller providing Scope 1 emissions reports directly to a user network, according to one implementation.

The system 100A shows a multi-chamber process tool 102 that integrates multiple processing chambers within a single platform. These chambers perform various steps in semiconductor manufacturing, such as, but not limited to, etching, deposition, and oxidation. The processing tools may include etch tools, chemical vapor deposition (CVD) tools, atomic layer deposition (ALD) tools, remote plasma source (RPS) chambers, lithography tools, ion implantation tools, and physical vapor deposition (PVD) tools.

The multi-chamber process tool 102 is connected to a fabrication network 104 for process monitoring and data exchange. A system controller 110 manages the operation of all chambers and communicates with external systems. The fabrication network 104 sends process recipes and operational parameters and receives status updates and diagnostics. The system controller 110 controls chamber operation, adjusting settings as needed and collects process data for monitoring and feedback. A point-of-use (POU) abatement system 115 neutralizes or removes hazardous gases and byproducts from the process chambers before release. The POU abatement system 115 may receive operational data from the system controller 110 and sends system health and operational status back to the system controller 110. The multi-chamber process tool 102 sends exhaust gases to the POU abatement system 115 for neutralization. The POU abatement system 115 may dynamically adjust based on operating conditions.

The POU abatement system 115 is used as an illustrative example. Other types of abatement systems may also be used. In one example, a combustion (burn/wet burn) abatement system can be used. The combustion abatement system uses high-temperature flames to burn harmful gases, breaking them into simpler, less toxic molecules. In another example, a thermal (electrically heated) oxidation abatement system can be used. The thermal oxidation system uses high-temperature electric heaters instead of combustion to decompose toxic gases. Other types of abatement systems may also be used, such as wet scrubbing, dry scrubbing, etc.

The fabrication network 104 is a highly integrated digital infrastructure that enables real-time or near real-time communication, data exchange, and process coordination across multiple tools and subsystems. The fabrication network 104 connects multi-chamber process tools, system controllers, material handling systems, and facility-wide monitoring platforms to ensure synchronized and efficient production. The purpose of the fabrication network 104 is to optimize process efficiency, ensure data-driven decision-making, and maintain product quality in high-volume semiconductor production. The fabrication network 104 facilitates automated wafer tracking, process recipe management, and tool scheduling, minimizing idle time and maximizing throughput. In multi-chamber process tools, the fabrication network 104 synchronizes gas flow control, plasma generation, and chamber transitions, ensuring coordination across multiple processing stages.

The system controller 110 serves as a control system for managing and coordinating process tools, including multi-chamber systems, abatement units including POU abatement systems such as plasma-based abatement, combustion-based abatement, thermal oxidation systems, catalytic abatement systems, wet scrubbers, dry scrubbers, or combinations thereof, and reagent delivery systems. The system controller 110 is responsible for real-time or near real-time data acquisition, process automation, and communication with the fabrication network 104, ensuring seamless integration of tool operations within a larger manufacturing system. The purpose of the system controller 110 is to synchronize tool operations, monitor key process parameters, and ensure compliance with production recipes and environmental standards. Additionally, the system controller 110 can log process data, determined emissions data, and equipment performance metrics, supporting regulatory reporting and sustainability initiatives.

As such, the system controller is configured to correlate the process data with at least one of a tool state, process recipe parameter, a chamber step, a process type, or an abatement operating state to determine emissions values for a selected tool, chamber, process step, or reporting interval. The system controller is configured to determine the direct greenhouse-gas emissions using a methodology at least as restrictive as (or consistent with) Intergovernmental Panel on Climate Change (IPCC) Tier 2b emissions factors or IPCC Tier 2c emissions factors. The system controller is configured to determine the direct greenhouse-gas emissions by combining gas-flow data, process-type data, and abatement-performance data to generate tool-specific emissions values. The system controller is configured to transmit a report to the remote user system through at least one of a user portal, an application programming interface, a cloud-based reporting platform, or an automated electronic message. The system controller is configured to automatically generate and transmit an updated report according to a schedule or in response to a triggering event.

The POU abatement system 115 neutralizes hazardous process gases before they are released into the environment. Semiconductor fabrication involves the use of PFCs, sulfur hexafluoride (SF₆), nitrogen trifluoride (NF₃), and other high-global-warming-potential (GWP) gases in processes like etching, deposition, and chamber cleaning. These gases, if not properly treated, contribute to greenhouse gas (GHG) emissions. The POU abatement system 115 may include plasma-based abatement, combustion-based abatement, thermal oxidation systems, catalytic abatement systems, wet scrubbers, dry scrubbers, or combinations thereof, which are configured to reduce emissions or hazardous and high-GWP gases. One purpose of the POU abatement system 115 is to reduce emissions of hazardous and high-GWP gases while supporting compliance with environmental regulations.

The system controller 110 collects and integrates data needed for Scope 1 emissions reports. The system controller 110 may facilitate that the emissions data is compiled, processed, and reported in compliance with industry standards.

Scope 1 emissions data 112 refers to direct GHG emissions from sources that a company owns or controls. The Scope 1 emissions data 112 can be provided in a Scope 1 emissions report 114. The Scope 1 emissions report 114 provides a detailed account of direct GHG emissions from sources the company owns or controls. Given the energy-intensive nature of semiconductor fabrication, a supplier-generated Scope 1 report can provide transparency to users about emissions associated with multi-chamber process tools and their operation. In one example, the users may be customers.

The Scope 1 emissions report may include emissions data by source, greenhouse gas breakdown, equipment-specific data for multi-chamber process tools, data measurement and reporting standards, and mitigation and reduction strategies. An example Scope 1 emissions report 114 for etching and deposition may include example emissions values such as, e.g., CO₂-equivalents (CO₂e) from process gases: 1,300 metric tons.

In some implementations, estimated fugitive emissions (hydrofluorocarbon (HFC) leaks): 300 metric tons.

Stationary combustion (e.g., natural gas for facility heating, combustion-based point-of-use (POU) abatement systems, thermal oxidation abatement systems, or other fuel-based abatement equipment): 500 metric tons.

The Scope 1 emissions report 114 may also include reduction efforts, such as:

Installed advanced abatement (improved PFC destruction efficiency).

Switched to low-GWP gases.

An example Scope 1 emissions report 114 for a multi-chamber process tool supplier may include a list of emissions, such as:

Emissions from equipment testing:

SF₆ and NF₃ use per chamber: 50 metric tons CO₂e.

In some implementations, additional environmental metrics may include power consumption: 2,500 megawatt-hour (MWh).

The Scope 1 emissions report 114 may also include reduction efforts, such as:

Implemented chamber purge gas recovery system.

Optimized vacuum pumps to lower gas flow rates.

Scope 1 emissions can be determined based on process gas usage, to a fab or to each semiconductor tool type in a fab, and using Intergovernmental Panel on Climate Change (IPCC) Tier 2b emissions factors or IPCC Tier 2c emissions factors, respectively. Such approach is beneficial for Scope 1 emission reporting because each process type has a different gas consumption profile (e.g., etching vs. deposition) and different process gases have different emission factors.

The IPCC methodologies are used for estimating GHG emissions from industrial sources, including semiconductor manufacturing. These methodologies provide different levels of accuracy and specificity in emissions calculations, particularly for Scope 1 emissions (direct emissions from facility operations).

The Tier 2b approach is applied at the fab-wide level (i.e., facility level gas usage). Such approach determines emissions based on facility-level gas consumption data. The Tier 2b approach uses default emission factors from the IPCC guidelines to estimate emissions based on gas usage. This approach does not account for specific tool-level abatement efficiencies but considers an overall fab-wide destruction efficiency.

The Tier 2c method is applied at the semiconductor tool type level, that is, estimating emissions per tool type (including etch, thin-film deposition, chamber clean, to name a few). Such approach breaks down gas usage and emissions per tool type and uses tool-specific emission factors rather than fab-wide averages. Such approach accounts for process variations and potentially different destruction efficiencies of abatement systems at the tool level.

Tier 2c relies on tracking what share of a fab's total gases are distributed between each tool or process type, possibly using measured, monitored, or inferred operational data, or fab-wide materials utilization and tool-specific emissions factors, rather than using fab-wide estimates. By categorizing emissions data by tool type, fabs can account for different gas usage and conversion efficiencies, improve the accuracy of greenhouse gas emissions assessment, and refine emissions reporting and regulatory compliance.

In one example, regarding different gas usage and conversion efficiencies, etch processes typically use PFCs and SF₆, which may have low conversion efficiency in the chamber, leading to higher direct emissions. RPS chambers use gases like NF₃ for chamber cleaning, which can have high conversion efficiency, but residual emissions depend on dissociation rates and abatement effectiveness. CVD processes may introduce different reactive byproducts that impact emissions calculations. Regarding improvement of accuracy of abatement system performance assessment, abatement systems have different destruction efficiencies depending on the gas and process type. Tier 2c may use measured, monitored, or inferred operational data, thus categorizing data by etch, RPS, CVD, etc. allows fabs to better model actual destruction rates and optimize abatement strategies. Regarding refinement of emissions Tier 2c data may provide additional granularity when available because Tier 2c provides process-level data rather than averaged assumptions. Process-specific separation enables fabs to isolate high-emission areas, prioritize mitigation efforts, and track reductions with improved resolution over time.

As such, by separating emissions data by process type, fabs can apply Tier 2c factors more effectively, leading to more accurate emissions estimates, better abatement efficiency tracking, and improved regulatory reporting. This method helps improve gas usage, reduce greenhouse gas impact, and enhance sustainability efforts in semiconductor manufacturing.

Reporting Scope 1 emissions from the POU abatement system 115, including plasma-based abatement, combustion-based abatement, thermal oxidation systems, catalytic abatement systems, wet scrubbers, dry scrubbers, or combinations thereof, to the user/customer (e.g., to the user network 120) involves providing detailed data about the greenhouse gases emitted during the process of treating exhaust gases using one or more abatement technologies. The user network 120 may include digital infrastructure and communication interfaces. The user network 120 may also include cloud-based platforms and automated data-sharing protocols.

In one example, abatement systems, such as plasma-based abatement systems, combustion-based abatement systems, and thermal oxidation systems, are employed in semiconductor manufacturing and similar industries to treat process gases used and generated during processing and minimize environmental impact.

Combustion-based abatement systems may generate direct greenhouse gas emissions, such as carbon dioxide, due to oxidation of fuel gases used during operation. In contrast, plasma-based abatement systems generally do not rely on fuel combustion and therefore do not inherently generate carbon dioxide through combustion processes, but may result in residual greenhouse gases and reaction byproducts depending on process conditions, gas composition, and abatement efficiency. Such residual gases and byproducts may contribute to Scope 1 emissions.

In operation, emissions result from the breakdown of process gases (e.g., PFCs, NF₃) during the abatement process. Combustion or chemical reactions during abatement may release, e.g., CO₂, NOₓ, or other byproducts. Continuous monitoring systems measure emissions directly at the point of abatement. Data includes types and quantities of gases released, calculated in CO₂-equivalents (CO₂e). Reporting then takes place where reports align with global standards, such as the Greenhouse Gas Protocol or local regulatory requirements. Data is shared with users in a transparent and structured format, often through periodic reports, dashboards, or integration into the users' emissions tracking systems. Then, emission measurements undergo regular calibration and third-party verification to ensure reliability. Reports may include details on abatement efficiency, baseline emissions, and reductions achieved through the abatement process.

In the context of reporting Scope 1 emissions from an abatement process (e.g., plasma, combustion, thermal oxidation, etc.), the ability to quantify emissions hinges on accurate measurements and an understanding of the destruction and removal efficiency of the abatement system. Scope 1 emissions represent direct emissions from operations controlled by an organization, and in, e.g., plasma abatement, these emissions include the residual gases that remain after abatement and byproducts generated during the process.

In one example, a process gas such as tetrafluoromethane (CF₄), a potent greenhouse gas commonly used in semiconductor manufacturing can be measured. When CF₄ enters, e.g., an abatement system (e.g., plasma-based abatement or combustion-based abatement system), the system's purpose is to decompose or neutralize it through chemical reactions, converting it into other reaction products. For example, the abatement system may have a 90% destruction efficiency for CF₄. This means that if 1 kilogram of CF₄ flows into the system, 0.9 kilograms are successfully destroyed, while 0.1 kilograms remain as residual emissions. These residual emissions, along with any byproducts (e.g., CO₂ or other greenhouse gases), are classified as Scope 1 emissions.

Nitrogen oxides, while potentially generated during certain abatement processes, are typically classified as hazardous air pollutants rather than greenhouse gases and therefore may be reported separately from Scope 1 and greenhouse gas emissions.

Using one or more sensors, such as flow meters, mass flow controllers, and/or gas analyzers, the abatement system measures flow rate and, in some implementations, composition of process gases such as, but not limited to, CF₄, NF₃, and CHF₃ entering the system. This data provides a baseline for calculating the total greenhouse gas emissions potential of the input. The destruction or removal efficiency of the abatement system is determined or estimated, often through regular calibration and testing. For CF₄, this may be 90%. The system calculates the residual CF₄ emissions by applying the destruction efficiency to the measured input flow. For example, if 10 kg of CF₄ flows in, the residual emissions are 10 kg×(1−0.9 )=1 kg.

Chemical reactions during abatement can produce additional greenhouse gases or byproducts, depending on abatement type and process conditions. The system estimates these byproducts based on reaction stoichiometry and process parameters. All emissions, including residual gases and byproducts, are converted into CO₂-equivalents (CO₂e) using their respective GWP values. This aggregation provides a single, standardized metric for reporting emissions.

Therefore, the detailed measurement and aggregation process allows suppliers to provide precise emissions data directly to users. Instead of users/customers estimating emissions based on broad assumptions, suppliers offer bottom-up data based on actual gas usage per tool/process derived from measured or monitored operational data, that is, emissions estimated based on real tool data (e.g., gas flow data obtained from tools, controllers, abatement systems, etc.) using IPCC Tier 2c. This enables emissions calculations based on measured or periodically collected operational data rather than generalized estimates. Customers receive clear insights into the emissions associated with specific processes and equipment.

Data collected from, e.g., an abatement system and associated sensors may include residual GHGs, byproduct GHGs, fuel-combustion-related emissions (when applicable), and, in some implementations, fugitive emissions. Residual GHGs are gases that are not completely destroyed by the abatement system. If a process gas, CF₄ for example, enters the system and has a destruction efficiency of 90%, the remaining 10% is directly emitted. Byproduct GHGs may include carbon dioxide or other greenhouse gases, depending on the input gases and reaction conditions. In one example, fluorocarbon destruction may generate CO₂ as a byproduct.

If the abatement system uses combustion-based abatement, emissions like CO₂ and other reaction byproducts may result from the combustion process. In some implementations, fugitive emissions may include leaks or unintended releases of gases from gas delivery lines, valves, or manifolds, which may be detected using gas sensors, pressure monitoring, or anomaly detection techniques.

Data collected from, e.g., an abatement system, semiconductor processing tools, and associated sensors may include input gas flow rates, destruction efficiency, residual gas emissions, byproduct gas quantification, emission factors, and, in some implementations, system losses or leak-related conditions.

For example, input gas flow rates may be determined from gas delivery systems supplying process gases to semiconductor processing chambers, and may be obtained using mass flow controllers or gas flow meters. In many implementations, direct measurement of total flow entering the abatement system may not be available. Instead, the abatement inlet flow may be estimated or inferred from a combination of process gas flow rates applied to the chamber, reaction by products generated in the chamber, and additional gases introduced upstream of the abatement system, such as purge gases or dilution gases. For example, vacuum pump or rough pump may introduce dilution gases such as nitrogen, that contribute to total flow entering the abatement system.

The Scope 1 emissions reports 114 generated from the collected data (e.g., the Scope 1 emissions data 112) may be provided to the user continuously, periodically, at timed intervals, or triggered due to spikes or notifications. In one example, emissions data is captured in real-time or at periodic intervals and forwarded to users. Sensors, flow meters, and gas analyzers can be integrated into semiconductor processing tools, gas delivery systems, exhaust systems and/or abatement systems to measure process gas flows, residual emissions, and process byproducts, and to determine destruction efficiency.

In another example, emissions data is aggregated and reported in set intervals, such as daily, weekly, or monthly. The reporting may be scheduled based on industry standards (e.g., monthly environmental audits) or user requirements (e.g., daily reports for high volume emitters). In another example, the emissions data may be sent at fixed intervals (e.g., every hour). In other examples, the reports may be triggered based on specific events, such as exceeding emission thresholds, drops in destruction efficiency, equipment malfunctions or maintenance needs. Other events may include detected increases in residual emissions, drops in abatement efficiency, and large variations in gas input or inferred gas flow conditions.

The benefits of providing more accurate emissions data directly to users include simplified user reporting, support of sustainability goals, enhanced collaboration, and regulatory readiness. Customers integrate determined or calculated Scope 1 emissions data into their own sustainability metrics without needing to perform additional calculations or rely on estimates. The granular data enables targeted emissions reduction strategies, helping organizations meet climate commitments, such as net-zero targets or Science-Based Targets (SBTs). By sharing emissions data, suppliers and users work together to identify areas for improvement, such as increasing abatement efficiency or switching to less impactful process gases. As stricter emissions reporting requirements are imposed, providing pre-aggregated data supports regulatory compliance and reduces administrative burdens.

The bottom-up approach, where suppliers provide emissions data based on actual gas usage per tool/process derived from measured or monitored operational data, that is, emissions estimated based on real tool data (e.g., gas flow data obtained from tools, controllers, abatement systems, etc.) using IPCC Tier 2c, delivers significant benefits over traditional methods where users estimate emissions.

Suppliers can use near real-time or periodic monitoring systems to measure specific gas flow rates, and determine destruction efficiencies, and, in some implementations, byproduct concentrations. This results in more accurate emissions data tailored to actual operational conditions, reducing the inaccuracies inherent in broad assumptions. Estimations often rely on generalized emissions factors, which fail to account for equipment-specific or site-specific variations. Bottom-up reporting can provide consistent and reproducible results, enhancing reliability.

With increasingly stringent regulations, such as those from the Greenhouse Gas Protocol, users need documented emissions data. Bottom-up reporting can support these requirements with documented, data-driven emissions calculations. Customers can integrate supplier-provided data directly into their compliance and reporting frameworks, reducing the complexity and time involved in emissions estimation.

Customers can rely on the improved reliability of data derived from measured or monitored operational data associated with semiconductor processing tools and abatement systems rather than on approximations. This fosters greater trust between suppliers and users. By providing detailed emissions profiles, suppliers demonstrate transparency and commitment to environmental responsibility, enhancing their reputation in the market. Customers save resources that would otherwise be spent on estimating emissions, including hiring consultants, gathering data, or developing complex estimation models. Direct data reporting can reduce the potential for inaccuracies or miscalculations, minimizing costly revisions or compliance penalties.

With more accurate emissions data, users can identify specific hotspots in their operations or supply chain and implement targeted strategies to reduce their carbon footprint. Suppliers'detailed reporting helps users align their activities with global climate initiatives, such as achieving carbon neutrality or SBTs. By reducing the burden on users and supporting their sustainability objectives, suppliers enhance loyalty and long-term collaboration.

Therefore, the transition from user-estimated emissions to supplier-provided, bottom-up reporting based on actual process parameters offers substantial benefits. It can improve accuracy, simplify compliance, build trust, and support sustainability goals while giving suppliers a potential competitive edge. By adopting this approach, both suppliers and users contribute to more transparent, responsible, and effective emissions management, advancing their environmental and business objectives.

FIG. 1B is a block diagram 100B of an emissions-data acquisition, processing, storage, and reporting architecture including semiconductor processing tools, a sensor layer, an abatement system, a system controller, local and remote data storage, and a user/customer reporting layer, according to one implementation.

One or more semiconductor processing tools 130 are configured to perform substrate-processing operations and may include, for example, etch tools, chemical vapor deposition (CVD) tools, atomic layer deposition (ALD) tools, physical vapor deposition (PVD) tools, remote plasma source (RPS) chambers, ion implantation tools, lithography tools, chamber-clean modules, or combinations thereof. The semiconductor processing tools 130 generate process-related data associated with tool operation, such as tool state, recipe parameters, process-step timing, chamber status, gas usage or gas delivery data, maintenance state, and operational diagnostics. In some implementations, such data may be generated continuously, periodically, or in response to a process event.

FIG. 1B further shows a sensor layer 140 coupled to or otherwise associated with the semiconductor processing tools 130 and/or downstream exhaust handling and abatement hardware. The sensor layer 140 may include mass flow controllers (MFCs) and/or gas flow meters 142, gas analyzers 144, and exhaust/residual gas sensors 146. The MFCs and/or gas flow meters 142 may be configured to determine flow rates, cumulative gas consumption, line pressure, or other gas-delivery parameters for process gases supplied to the semiconductor processing tools 130. The gas analyzers 144 may be configured to identify gas species, determine gas composition, detect byproducts, and measure or infer concentrations of greenhouse gases and related compounds. The exhaust/residual gas sensors 146 may be positioned to detect post-process or post-abatement gases and may be used to determine residual greenhouse-gas emissions, byproduct emissions, and, in some implementations, leak-related conditions, or other exhaust conditions. In some implementations, the sensor layer 140 may include additional sensing devices, such as pressure sensors, temperature sensors, plasma diagnostics, valve-position sensors, power monitors, diagnostic sensors, or combinations thereof.

An abatement system 150 is disposed downstream of the semiconductor processing tools 130 and may be configured to receive and treat exhaust gases generated by one or more of the semiconductor processing tools 130. The abatement system 150 may include, for example, a plasma abatement system, a combustion abatement system, a thermal oxidation system, a wet scrubber, a dry scrubber, or a combination of multiple abatement stages. In some implementations, the abatement system 150 provides operating data that may include data used to determine destruction efficiency, gas residence time, temperature, pressure, power level, oxidant flow, system health information, fault conditions, maintenance information, and byproduct-generation information. Such data may be provided directly or indirectly to a system controller 160 for processing. The abatement system 150 may also receive control instructions, setpoint adjustments, maintenance commands, or other operating directives from the system controller 160.

In some implementations, the abatement system 150 may include a point-of-use (POU) abatement system configured to treat greenhouse gases and process gases generated by semiconductor processing tools. The POU abatement system may include, for example, plasma-based abatement systems, combustion-based abatement systems, thermal oxidation systems, catalytic abatement systems, wet scrubbers, dry scrubbers, or combinations thereof. Accordingly, although certain examples herein describe plasma abatement systems, the systems and methods described herein are not limited to plasma-based abatement and may be applied to any abatement system configured to reduce greenhouse gases, PFCs, or other process gases generated during semiconductor manufacturing or related industrial processes. Furthermore, in some implementations, multiple abatement systems may be used in series or parallel, and the system controller 160 may receive data from one or more of such abatement systems.

The system controller 160 is configured to receive and process data from the semiconductor processing tools 130, the sensor layer 140, and the abatement system 150. In the example, the system controller 160 includes multiple functional layers, which may be implemented in hardware, software, firmware, or combinations thereof.

A data acquisition layer 162 receives sensor signals, telemetry, process data, and status information from distributed inputs and may perform timestamping, synchronization, filtering, buffering, and validation of incoming data. In some implementations, the data acquisition layer 162 correlates gas-flow data or inferred gas-flow information with process steps, recipe states, chamber states, and abatement operating conditions so that emissions calculations can be attributed to a selected tool, chamber, process type, or time interval.

A communications layer 164 provides interfaces for exchanging data with internal and external systems. In some implementations, the communications layer 164 supports one or more industrial communication protocols or network interfaces, such as, industrial Ethernet, fieldbus communications, serial interfaces, secure application programming interfaces (APIs), web services, or combinations thereof. The communications layer 164 may be configured to normalize data from heterogeneous tools and subsystems so that data received from different equipment manufacturers or monitoring devices can be processed in a consistent manner by the system controller 160. In some implementations, the communications layer 164 also supports secure outbound transmission of emissions reports, alerts, audit data, or raw and processed emissions information to external user systems.

A processing/calculation layer 166 is configured to determine emissions-related values from the received process and sensor data. By way of example, the processing/calculation layer 166 may categorize gases according to tool type and process type, determine gas usage or inferred gas usage for a selected process step or chamber, determine abatement-system performance, determine residual emissions and byproduct emissions, apply one or more emissions-estimation methodologies, and convert determined emissions into carbon-dioxide-equivalent values or other standardized reporting formats. In some implementations, the processing/calculation layer 166 may apply a methodology such as Intergovernmental Panel on Climate Change (IPCC) Tier 2b emissions factors or IPCC Tier 2c emissions factors, while in other implementations the layer may apply process-specific physical models, empirical models, rules-based calculations, or combinations thereof. Because the processing/calculation layer 166 operates on measured, monitored or inferred operational data collected from the industrial environment, it can provide greater granularity and improved technical accuracy relative to facility-level estimates derived solely from procurement or aggregate consumption records.

A rules/analytics layer 168 may analyze outputs of the processing/calculation layer 166 and may apply threshold logic, anomaly detection, trend analysis, or predictive analytics. In some implementations, the rules/analytics layer 168 determines whether an emissions threshold has been exceeded, whether abatement efficiency has fallen below a threshold, whether a gas-consumption pattern is abnormal, whether a potential leak-related condition is indicated, or whether predicted emissions for an ongoing or upcoming process run are expected to exceed a target value. The rules/analytics layer 168 may implement fixed rules, adaptive rules, statistical analytics, or machine-learning models, depending on the implementation. Outputs of the rules/analytics layer 168 may include alert conditions, maintenance recommendations, predicted emissions values, fault indicators, recommended corrective actions, or control triggers.

A report/control layer 169 is configured to generate, format, and distribute emissions-related outputs and, in some implementations, to initiate control actions. For example, the report/control layer 169 may generate a report satisfying direct greenhouse-gas emissions reporting requirements, generate periodic reports, produce event-triggered alerts, prepare downloadable compliance exports, or publish machine-readable emissions data to a remote endpoint. In some implementations, the report/control layer 169 may additionally support closed-loop operation by causing one or more operating parameters of the semiconductor processing tools 130 or the abatement system 150 to be modified in response to determined emissions values, predicted emissions, threshold exceedances, drops in destruction efficiency, or abnormal operating conditions. Such modifications may include adjusting process gas flow rates, process recipe settings, step durations, plasma power, oxidant flow, or maintenance scheduling.

FIG. 1B also illustrates local data storage 170 and remote/cloud data storage 172 coupled to the system controller 160. The local data storage 170 may include, for example, controller memory, local databases, an edge-computing device, or a local server configured to store raw data, intermediate calculations, time-series sensor values, generated reports, calibration records, audit logs, or combinations thereof. The remote/cloud data storage 172 may include cloud databases, remote analytics platforms, enterprise reporting systems, or archival storage configured for longer-term retention, cross-site analytics, model training, customer access, or regulatory reporting support. In some implementations, the system controller 160 stores data locally for low-latency processing or buffering during network outages and synchronizes selected data with the remote/cloud data storage 172 when connectivity is available.

A user/customer reporting layer 180 is configured to receive outputs from the system controller 160 directly or through one or both of the local data storage 170 and the remote/cloud data storage 172. The user/customer reporting layer 180 may include a user portal, dashboard, API endpoint, downloadable report interface, audit-log interface, automated messaging service, compliance-reporting system, or combinations thereof. Through the user/customer reporting layer 180, a user may receive real-time emissions data, periodic emissions reports, threshold alerts, audit-ready exports, historical trend views, equipment-specific emissions values, gas-specific emissions values, carbon-dioxide-equivalent summaries, or recommended corrective actions. In some implementations, the user/customer reporting layer 180 may be accessed by a user operating the semiconductor processing tools 130, a supplier operating the system controller 160 or abatement system 150, a sustainability team, a regulatory-compliance team, or another authorized entity.

In operation, FIG. 1B illustrates a data pipeline in which process and emissions-related information flows from the semiconductor processing tools 130, the sensor layer 140, and the abatement system 150 into the system controller 160 for acquisition, communication handling, calculation, analytics, and reporting. This architecture provides a more concrete technical framework for determining and reporting direct greenhouse-gas emissions than existing manual or spreadsheet-based workflows. In particular, the architecture of FIG. 1B enables tool-level and process-specific emissions attribution, lower-latency emissions determination, improved data integrity through controller-based data integration, and, in some implementations, feedback-based optimization of tool and abatement operation. Accordingly, FIG. 1B provides support for implementations in which emissions reporting is integrated into an industrial control and monitoring architecture rather than being performed solely as an after-the-fact administrative calculation.

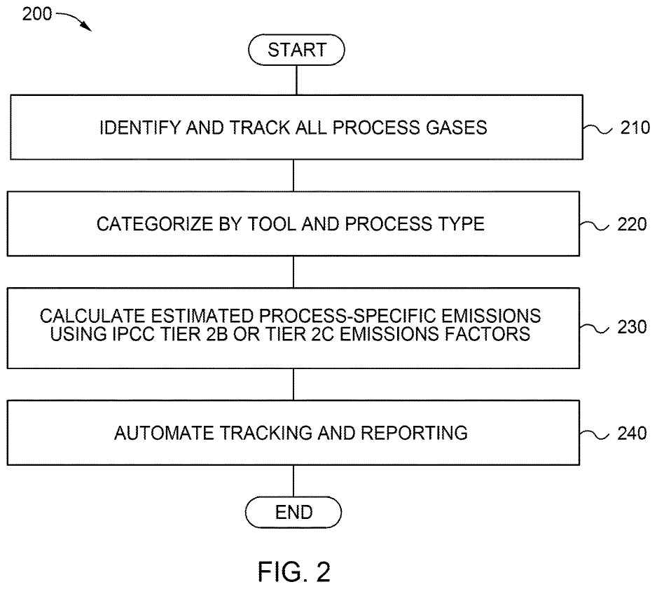

FIG. 2 is a flowchart of a method for identifying and tracking Scope 1 emissions, according to one implementation.

At block 210, all process gases are identified and tracked. The method uses gas flow data obtained from mass flow controllers, gas flow meters, or tool recipe settings to determine or estimate gas flow. Gas consumption per tool type and process step may be determined and stored.

Semiconductor manufacturing relies on a variety of gases, including PFCs, NF₃, SF₆, HFCs, and other GWP gases for processes like etching, deposition, and chamber cleaning. Each gas has a unique molecular structure, reactivity, and emission profile, which should be accounted for in emission calculations. This involves monitoring using measured, inferred, or periodically collected data using mass flow controllers (MFCs), gas analyzers, and available abatement system sensors to record gas flow rates, consumption patterns, and residual or inferred emissions.

At block 220, the gases are categorized by tool and process type. Each gas is used differently across tool types and emissions vary depending on utilization rate and determined destruction efficiency.

Once gases are identified, they are categorized by the specific process tool and manufacturing step where they are used. This categorization ensures that emissions estimates are aligned with process-specific variables, such as plasma etching, CVD, PVD, or chamber cleaning cycles. Different tools have varying efficiencies, operational parameters, and gas conversion characteristics, meaning emissions will differ based on the type of equipment and the way gases are consumed. By mapping gas usage to specific process chambers and toolsets, manufacturers can identify potential inefficiencies, optimize abatement strategies, and support compliance with regulatory standards. This classification also facilitates trend analysis, allowing fabs to pinpoint areas where gas usage can be reduced without compromising production yield or quality.

At block 230, estimated process-specific emissions are calculated using IPCC Tier 2c emissions factors. If the data are separated by process type (i.e., etch, RPS chamber clean, CVD, PVD, etc.) then Tier 2c factors can be used to provide a more process-specific estimate of emissions.

At block 240, tracking and reporting are automated by integrating real-time or periodic data collection, machine learning (ML) based predictive analytics, and automated compliance reporting tools. The Scope 1 emissions report is automated and provided directly to the user/customer from the supplier. This is referred to as a bottom-up approach as suppliers can use advanced monitoring and data collection technologies to determine or estimate Scope 1 emissions and report directly to the user or customer.

Tracking and reporting involves connecting gas flow sensors, system controllers, abatement monitoring devices, and fabrication networks to a centralized environmental data platform that collects and logs emissions data. Automated reporting supports compliance with global regulatory frameworks and corporate sustainability targets. Additionally, artificial intelligence (AI)-driven analytics can identify abnormal gas consumption patterns, potential leak-related conditions, or inefficient tool operations, allowing for proactive adjustments to reduce emissions. By automating this process, semiconductor manufacturers can improve reporting accuracy, enhance sustainability efforts, and optimize operational efficiency while reducing manual tracking efforts.

In one example, ML techniques can enhance the tracking and reporting of incoming gases for Scope 1 emissions in semiconductor manufacturing by improving accuracy, efficiency, and/or predictive capabilities. By using sensor data, tool-specific gas consumption logs, and historical emissions records, ML models can classify and correlate gas usage patterns to individual tools and process types. This enables real-time tracking of high GWP gases like NF₃, CF₄, and SF. ML algorithms, such as time-series forecasting and anomaly detection, can identify deviations in gas consumption, flagging potential leak-related conditions, inefficiencies, or misreported emissions data before they lead to regulatory non-compliance. Beyond tracking, ML-driven systems can automate Scope 1 emissions reporting by aggregating gas flow data from multiple process tools, estimating unmeasured emissions, and applying process-specific emissions factors dynamically. In some implementations, reinforcement learning (RL) or optimization algorithms may be used to evaluate gas reduction strategies, optimizing abatement efficiency while minimizing waste and environmental impact. Additionally, natural language processing (NLP) can assist with compliance reporting by automatically generating regulatory reports and audit-ready documentation, reducing the manual burden on fab operators.

In one practical application, in semiconductor fabrication, NF₃ is used for plasma chamber cleaning. However, the breakdown of NF₃ varies by process type, leading to differences in emissions.

For RPS, NF₃ breakdown may include:

NF₃ is pre-dissociated before entering the process chamber. The RPS converts NF₃ into reactive fluorine radicals in a plasma generator outside the chamber. The fluorine radicals react with residues on the chamber walls to clean the surface. Since NF₃ is substantially dissociated (~>98%) before reaching the chamber, a reduced portion of NF₃ may remain unreacted. RPS may achieve relatively high NF₃ dissociation efficiency before any gas reaches the exhaust

For in-situ plasma etch cleaning, NF₃ breakdown may include:

NF₃ is injected directly into the chamber and activated by an RF plasma source inside the chamber. The plasma inside the chamber breaks a portion of the NF₃ molecules (~80%), which may result in lower dissociation efficiency compared to remote plasma systems. A portion of NF₃ may leave the chamber unreacted and enters the exhaust stream. As a result, a larger fraction of NF₃ may be directed to downstream abatement systems.

The advantages of such examples include enhanced accuracy in emissions estimation, tool-specific emissions profiling, potential corrective actions, improved abatement system efficiency and compliance, improved carbon footprint for sustainability goals, and optimization of gas consumption and cost reduction. Providing such detail in a Scope 1 emission report directly to the user from the supplier (bottom-up approach) gives a more accurate estimate of GHG emissions.

Semiconductor tools, including, e.g., etch, RPS chamber cleaning, PVD, and CVD, consume different gases at different rates, with varying conversion efficiencies and emission profiles. Fabs can apply tool-specific Tier 2c factors that better reflect actual emissions behaviors. For example, etching processes may have lower gas conversion rates and benefit from high-precision abatement, whereas RPS cleaning processes may have higher dissolution efficiencies but still benefit from close monitoring of residual emissions. The example approach helps ensure that emissions data is not overestimated or underestimated due to generalized assumptions.

Totaling the amounts of key incoming gases to a fab or to each semiconductor tool type in a fab provides better visibility into abatement system effectiveness. Since different gases have different destruction efficiencies depending on process conditions, tool-specific tracking allows manufacturers to determine or estimate post-abatement emissions.

Estimating Scope 1 emissions by totaling the amounts of incoming gases to a fab or to each semiconductor tool type in a fab, and using IPCC Tier 2b and IPCC Tier 2c emissions factors, respectively, fabs can identify areas where gas consumption may be optimized without impacting process performance. For example, if a specific etch tool is consuming more PFCs than expected, engineers can investigate potential overuse or inefficiencies. If an RPS chamber cleaning process is using lower than expected amounts of NF₃, adjustments may be evaluated to improve gas utilization efficiency and reduce waste. By comparing process-specific emissions data, fabs can benchmark tool performance and identify best practices for reducing gas consumption and emissions. Reducing excess gas consumption not only lowers emissions but also reduces operational costs associated with gas procurement and abatement.

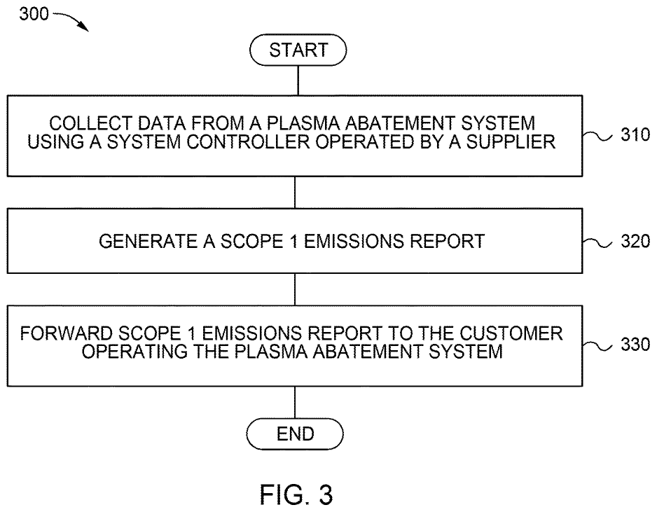

FIG. 3 is a flowchart of a method for reporting Scope 1 emissions directly to the user, according to one implementation.

At block 310, data is collected from an abatement system (e.g., plasma, combustion, thermal oxidation, etc.) via a system controller operated by a supplier. Data collected from the abatement system (e.g., plasma, combustion, thermal oxidation, etc.) may include operating parameters and data associated with incoming gases, data used to determine destruction efficiency, residual gas emissions, byproduct gas quantification, emission factors, and system losses or leak-related conditions.

At block 320, a Scope 1 emissions report is generated. The Scope 1 emissions report may include details about process emissions, combustion emissions, and, in some implementations, fugitive emissions. Other data may include volume or mass flow rate of gases, duration of operations, determined destruction or removal efficiency, emission factors, emission calculations, aggregated emissions, emissions trends (e.g., historical trends), identification of high-emission sources, variability due to operational changes, etc.

At block 330, the Scope 1 emissions report is forwarded to the user operating the abatement system (e.g., plasma, combustion, thermal oxidation, etc.). Real-time emissions data or reports allows users to monitor the effectiveness of the abatement system, detect and address performance issues, and optimize upstream processes to minimize harmful gas flows to the abatement system. Further, forwarding of emissions data may provide notification of unexpected emissions spikes or system malfunctions, enabling rapid response.

Benefits of the present disclosure include users gaining more accurate data on emissions attributable to their processes, aiding their Scope 1 emission reporting. The method further supports sustainability goals by providing actionable insights into emission hotspots. The method also supports users in meeting regulatory requirements for emission disclosure in their supply chains and simplifies user audits by providing documented, granular emission data. The method further encourages collaboration between users and suppliers to optimize the abatement process for greater emission reductions.

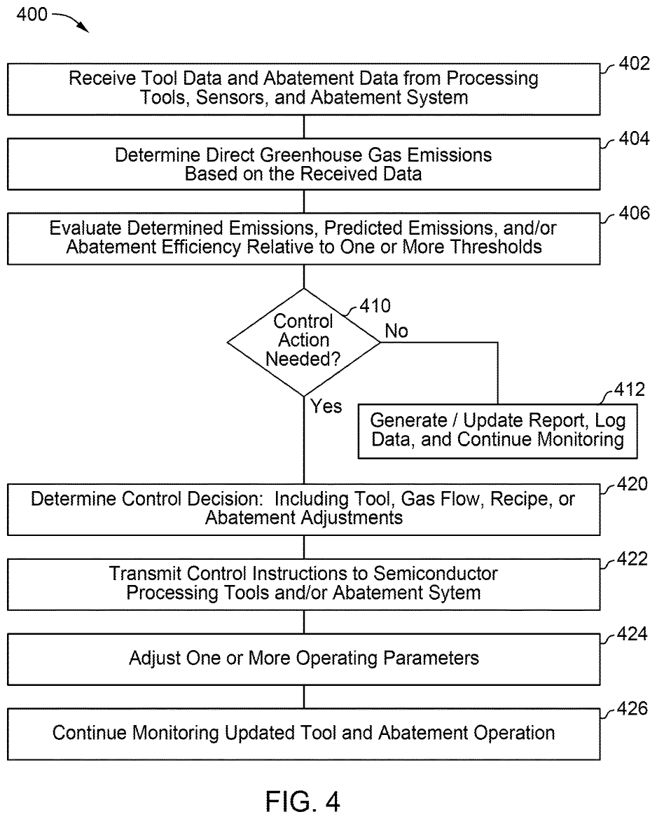

FIG. 4 is a flowchart of a closed-loop emissions control method in which a system controller determines emissions information from tool and abatement data, evaluates one or more control criteria, and selectively adjusts one or more operating parameters of semiconductor processing tools and/or an abatement system, according to one implementation.

The method 400 begins at 402, where tool data and abatement data are received from one or more processing tools, one or more sensors, and an abatement system. In some implementations, the received data may be provided by the semiconductor processing tools 130, the sensor layer 140, including one or more mass flow controllers (MFCs) and/or gas flow meters 142, gas analyzers 144, and exhaust/residual gas sensors 146, and the abatement system 150, as described with respect to FIG. 1B. The received data may include, by way of example, gas flow rates, gas composition data, tool state data, process recipe parameters, chamber step durations, exhaust measurements, data used for destruction efficiency, byproduct data, maintenance information, diagnostic information, and fault data.

At 404, direct greenhouse-gas emissions are determined based on the received data. In some implementations, the determination at 404 is performed by the system controller 160, for example by the data acquisition layer 162, the communications layer 164, the processing/calculation layer 166, the rules/analytics layer 168, and/or the report/control layer 169 working individually or in combination. The emissions determination performed at 404 may include categorizing gases according to tool type and process type, determining or estimating process-gas usage, determining abatement performance, determining residual greenhouse-gas emissions and byproduct emissions, applying one or more emissions-estimation methodologies, and converting emissions values into a carbon-dioxide-equivalent metric or another standardized reporting format. In some implementations, the emissions determination at 404 may be based on measured, monitored, or inferred operational data collected directly from the industrial environment rather than estimated solely from procurement data or aggregate facility-level assumptions.

At 406, the method 400 evaluates the determined emissions, predicted emissions, and/or abatement efficiency relative to one or more thresholds. The evaluation at 406 may include comparing actual emissions values to a threshold, comparing predicted future emissions values to a target emissions range, comparing determined destruction efficiency to a threshold efficiency value, detecting abnormal gas-consumption behavior, detecting unexpected byproduct formation, identifying a potential leak-related condition, or determining whether equipment performance has degraded. In some implementations, the evaluation at 406 may be carried out by the rules/analytics layer 168, which may apply threshold logic, trend analysis, statistical analysis, anomaly detection, predictive analytics, or machine-learning models. In this way, the method 400 may identify conditions in which corrective action is warranted before emissions exceed a desired level or before abatement performance materially degrades.

Following the evaluation at 406, the method proceeds to decision block 410, where the system determines whether a control action is needed. If no control action is needed at 410, the method proceeds to 412, where the system may generate and/or update a report, log data, and continue monitoring. The report generated or updated at 412 may be a report satisfying direct greenhouse-gas emissions reporting requirements, and may include tool-specific emissions information, gas-specific emissions information, abatement-performance information, threshold status, trend information, and carbon-dioxide-equivalent values. Logging at 412 may include storing raw sensor data, processed emissions values, event flags, threshold determinations, or audit information in local data storage 170, remote/cloud data storage 172, or both. In some implementations, information generated at 412 may also be provided to the user/customer reporting layer 180 for presentation through dashboards, portals, APIs, alerts, or downloadable reports.

If control action is needed at 410, the method proceeds to 420, where a control decision is determined. The control decision at 420 may include identifying one or more specific tools, subsystems, chambers, gases, or abatement components to be adjusted, as well as determining the nature and extent of the adjustment. In some implementations, the control decision may include modifying a process gas flow rate, modifying a process recipe parameter, modifying a chamber step duration, modifying plasma power, modifying abatement power, changing oxidant delivery, adjusting exhaust handling conditions, altering a maintenance interval, scheduling diagnostic testing, or initiating another corrective or preventive action. The control decision at 420 may be based on a rules-based framework, a predictive model, operator-defined thresholds, or combinations thereof.

At 422, one or more control instructions are transmitted to the semiconductor processing tools and/or the abatement system. In some implementations, the control instructions may be transmitted by the system controller 160, for example using the communications layer 164, which may support one or more communication mechanisms such as industrial Ethernet, fieldbus communications, APIs, or other wired or wireless interfaces. The transmitted control instructions may be directed to one or more semiconductor processing tools 130, to the abatement system 150, or to associated gas-delivery, exhaust-handling, or facility-control subsystems. In some implementations, the control instructions may be executed immediately, queued for execution at a subsequent process step, or subject to user confirmation depending on the control mode selected for a given deployment.

At 424, one or more operating parameters are adjusted in response to the transmitted control instructions. The adjusted operating parameters may include, for example, process gas flow rates, gas-delivery timing, process recipe settings, chamber step durations, plasma settings, abatement setpoints, oxidant flow values, pressure conditions, exhaust settings, or other parameters affecting emissions generation or emissions treatment. The adjustment at 424 may be applied to help reduce actual emissions, avoid predicted threshold exceedances, improve determined destruction efficiency, reduce residual greenhouse-gas emissions, reduce byproduct formation, or otherwise improve operation of the industrial processing environment. In this respect, the method 400 is not limited to passive emissions reporting, but instead supports active control of industrial equipment based on determined or predicted emissions conditions.

At 426, the method 400 continues monitoring updated tool and abatement operation. Monitoring at 426 may include acquiring new process and sensor data after the adjustment at 424, determining updated emissions values, evaluating whether the corrective action has improved operation, and determining whether additional control actions are needed. Thus, the method 400 forms a closed loop in which emissions-related data is continuously or periodically received, processed, evaluated, and used to inform further operational decisions. By repeating this cycle, the method 400 can improve emissions control responsiveness, improve abatement performance, reduce or optimize unnecessary process-gas consumption, and reduce reliance on delayed human review of emissions reports.

As such, determining the direct greenhouse-gas emissions includes categorizing process gases according to semiconductor tool type and process type prior to determining the direct greenhouse-gas emissions. Further, determining the direct greenhouse-gas emissions includes applying a facility-level emissions-estimation methodology to facility-level gas data and applying a tool-type-level emissions-estimation methodology to tool-type-level gas data. Determining the direct greenhouse-gas emissions is performed from controller-collected operational data without a need for relying solely on procurement records for emissions determination. Also, determining the direct greenhouse-gas emissions includes determining residual emissions from process gases remaining after abatement and determining byproduct emissions generated by the abatement system. Determining the direct greenhouse-gas emissions includes using a methodology at least as restrictive as Intergovernmental Panel on Climate Change (IPCC) Tier 2b emissions factors or IPCC Tier 2c emissions factors.

In some implementations, one or more of the operations of the method 400 may be performed in a different order, performed in parallel, omitted, repeated, or combined. For example, reporting and logging at 412 may also occur after control actions are taken at 420, 422, and 424, and predictive analysis may be performed before or during the evaluation at 406. In some implementations, the determination of direct greenhouse-gas emissions at 404, the evaluation at 406, the control decision at 420, and the transmission of control instructions at 422 may all be performed by the system controller 160 in cooperation with the local data storage 170, the remote/cloud data storage 172, and the user/customer reporting layer 180. Accordingly, FIG. 4 provides support for implementations in which emissions determination and reporting are integrated with active process and abatement control, thus improving technical operation of the underlying industrial equipment and supporting more accurate or process-specific, lower-latency, and more responsive emissions management.

As such, in some implementations, the system controller is not limited to collecting emissions-related data and generating reports, but is further configured to automatically modify operation of one or more semiconductor processing tools, one or more associated gas-delivery subsystems, and/or an abatement system based on determined emissions information. For example, the system controller may compare determined emissions, predicted emissions, determined destruction efficiency values, residual gas levels, byproduct levels, or combinations thereof against one or more thresholds or target operating ranges. In response, the system controller may adjust one or more operating parameters, such as process gas flow rates, process recipe parameters, chamber step durations, plasma power settings, abatement power levels, oxidant delivery rates, exhaust handling parameters, or maintenance intervals. In this manner, the example system may operate as a closed-loop emissions control architecture in which measured, monitored, or inferred, process data is used not only for reporting purposes, but also for dynamic optimization of process and abatement performance.

By way of example, when the system controller detects an emissions threshold exceedance, predicts that a current process run will produce emissions above a target level, or determines that abatement efficiency has dropped below a threshold value, the system controller may initiate a corrective action. Such corrective action may include modifying a process recipe for a subsequent wafer, batch, chamber-clean cycle, or deposition or etch step, reducing flow of a selected process gas, increasing abatement intensity, routing an alert to a user, or placing equipment into a diagnostic or maintenance mode. This closed-loop configuration can improve operational performance by reducing excess emissions, improving abatement effectiveness, and enabling faster response to changing process conditions than existing systems that generate periodic emissions summaries for later human review.

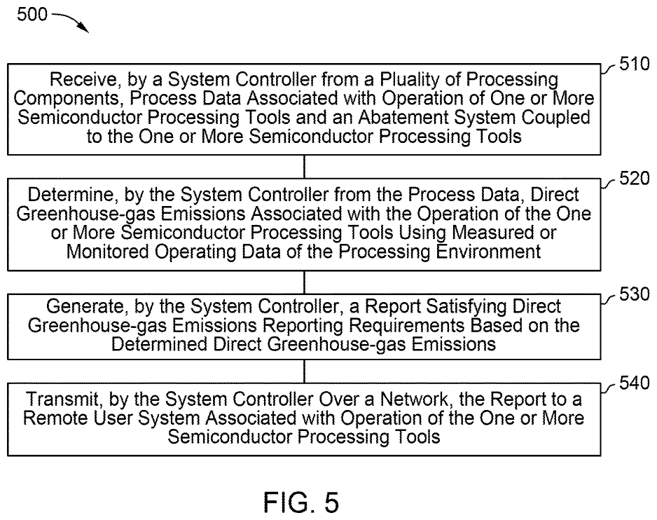

FIG. 5 is a method for controlling emissions reporting in a processing environment, according to one implementation.

At operation 510, the system receives, by a system controller from a plurality of processing components, process data associated with operation of one or more semiconductor processing tools and an abatement system coupled to the one or more semiconductor processing tools.

This operation may include the system controller obtaining process data from multiple sources within a processing environment, such as semiconductor processing tools, gas-delivery components, mass flow controllers, gas analyzers, exhaust sensors, residual gas sensors, and one or more abatement-system subsystems. The received process data may include, for example, gas flow rates, gas composition data, process recipe parameters, chamber step durations, tool state information, exhaust conditions, abatement operating parameters, data used to determine destruction efficiency, maintenance status, and diagnostic or fault information.

At operation, 520, the system determines, by the system controller, from the process data, direct greenhouse-gas emissions associated with the operation of the one or more semiconductor processing tools using measured, monitored, or inferred, operating data of the processing environment.

This operation may include analyzing the received process data to determine direct greenhouse-gas emissions attributable to operation of the semiconductor processing tools and, in some implementations, the coupled abatement system. The system controller may categorize process gases according to tool type, chamber, process type, or process step, and may determine gas usage, residual emissions, byproduct emissions, and abatement effectiveness based on measured, monitored, or inferred operating data rather than on generalized procurement-based estimates. In some examples, the system controller may apply emissions-estimation methodologies corresponding to facility-level or tool-level emissions factors, convert gas-specific emissions into carbon-dioxide-equivalent values, and generate emissions values for selected tools, chambers, time intervals, or reporting periods. This operation provides a process-integrated emissions determination that is more technically specific or process-integrated than prior facility-wide approximations and better aligned with the actual operating state of the environment.

At operation, 530, the system generates, by the system controller, a report satisfying direct greenhouse-gas emissions reporting requirements based on the determined direct greenhouse-gas emissions.

This operation may include creating a structured emissions output from the determined emissions values so that the output can satisfy one or more internal, customer, regulatory, sustainability, or audit-related reporting requirements. The generated report may include, for example, equipment-specific emissions information, gas-specific emissions information, aggregated carbon-dioxide-equivalent values, emissions trends, residual-emissions data, byproduct-emissions data, abatement-efficiency information, event or threshold indicators, and explanatory metadata identifying the reporting period, affected equipment, or underlying calculation basis. In some implementations, the report may be generated in human-readable and/or machine-readable form, such as a dashboard output, tabular report, downloadable file, compliance export, or structured data object for machine-to-machine communication. This operation transforms the determined emissions data into a usable reporting artifact that can support environmental accountability and operational decision-making. Generating the report thus includes generating equipment-specific emissions information for at least one semiconductor processing tool, emissions information by gas type, and aggregated carbon-dioxide-equivalent emissions information.

At operation, 540, the system transmits, by the system controller, over a network, the report to a remote user system associated with operation of the one or more semiconductor processing tools.

This operation may include sending the generated report from the system controller to a remote user system over one or more communication networks, such as an internal fab network, an enterprise network, a cloud network, or another wired or wireless data network. The remote user system may include, for example, a user portal, customer dashboard, application programming interface endpoint, sustainability reporting platform, compliance platform, or remote storage environment accessible by a user associated with operation of the semiconductor processing tools. In some implementations, transmission may occur in real time, near real time, on a scheduled basis, or in response to a triggering event such as an emissions threshold exceedance, a predicted threshold exceedance, or a detected equipment condition. By transmitting the report over a network to a remote user system, this operation enables direct delivery of emissions information to the relevant user without the need for the user to independently reconstruct emissions values from raw operational data. As such, transmitting the report includes transmitting the report in real time or near real time responsive to receipt of the process data. Further, transmitting the report includes transmitting the report in response to a triggering event comprising at least one of an emissions threshold being exceeded, a predicted emissions threshold being exceeded, a drop in determined abatement efficiency, a detected equipment fault, a detected potential gas leak condition, or a variation in gas flow exceeding a threshold.

In some implementations, the system controller may include or communicate with a predictive analytics engine that applies one or more machine-learning models to emissions-related process data. The input data to the one or more machine-learning models may include, for example, gas flow rates, gas composition data, chamber pressure, chamber temperature, plasma power, tool state information, process recipe parameters, step durations, abatement operating parameters, data used to determine destruction efficiency, residual gas measurements, byproduct gas measurements, maintenance history, fault logs, and historical emissions data for one or more semiconductor processing tools, chambers, abatement systems, process types, or facilities. The predictive analytics engine may preprocess the input data by filtering, normalizing, aggregating, and time-aligning data obtained from multiple sensors, controllers, and networked industrial components so that emissions-related patterns can be identified across different time intervals and operating states.

The one or more machine-learning models may include, by way of example, regression models for estimating emissions values or determined destruction efficiency from observed operating parameters, time-series forecasting models for predicting future emissions trends or threshold exceedances, and anomaly-detection models for identifying unusual gas-consumption patterns, abnormal residual emissions, unexpected byproduct formation, sensor drift, equipment degradation, or potential leak-related conditions. In some examples, the output of the one or more machine-learning models may include predicted direct greenhouse-gas emissions, predicted carbon-dioxide-equivalent values, anomaly flags, fault probabilities, estimated abatement-performance degradation, recommended maintenance intervals, or recommended process adjustments. The predicted values and anomaly indicators may be generated for a tool, chamber, process step, recipe, batch, time interval, abatement subsystem, or facility.

The system controller may use the outputs of the one or more machine-learning models to improve operation of the processing environment. For example, in response to a predicted emissions threshold exceedance, the system controller may generate and transmit an alert, schedule maintenance, increase monitoring frequency, modify a report, or automatically adjust one or more operating parameters of a semiconductor processing tool or abatement system. In response to an anomaly flag indicating abnormal gas usage or declining determined destruction efficiency, the system controller may trigger diagnostic testing, isolate suspect equipment, initiate recalibration of one or more sensors, or modify process gas flow rates, recipe settings, or abatement settings. In this manner, the machine-learning functionality may be used not merely to classify data for presentation, but to support improved emissions determination, earlier fault detection, and adaptive control of tool and abatement operation.

In some implementations, the one or more machine-learning models may be trained using historical process data and corresponding measured, determined, or calculated emissions outcomes from one or more tools, chambers, facilities, or users. Training may be performed offline and the trained models may then be deployed within the system controller, on a local server, or on a remote computing platform communicatively coupled to the system controller. The models may also be periodically retrained or updated based on newly collected operational data, validated or updated emissions measurements/determinations, maintenance records, or user feedback to improve prediction performance over time. In other implementations, machine-learning functionality may be omitted, and the system controller may instead determine emissions and generate reports using rules-based processing, threshold logic, emissions factors, physical models, or combinations thereof.

In conclusion, the drive toward sustainability and regulatory compliance has elevated the importance of accurately measuring and reporting greenhouse gas emissions. Many organizations, particularly in sectors like manufacturing and technology, are held accountable not only for their own emissions but also for those within their value chain. Traditionally, this has led to a top-down emissions reporting approach, where users rely on broad assumptions, aggregated data, or emissions factors to estimate their environmental impact. While this method provides a general overview, it may lack the granularity and granularity needed to meet increasingly stringent regulatory requirements and sustainability goals.

An alternative solution is the bottom-up emissions reporting approach, where suppliers directly provide determined or calculated emissions data to their users. This shift is beneficial in industries that utilize abatement systems (e.g., plasma, combustion, thermal oxidation, etc.) to mitigate the release of harmful process gases. By determining emissions based on process and operational data and aggregating data based on actual process parameters, suppliers can offer a level of detail that significantly improves the accuracy, transparency, and usability of emissions reports.

In the top-down approach, users usually rely on emissions factors, that is, industry-standard values that estimate the environmental impact of a specific process or material. For example, users may estimate emissions based on the amount of a gas purchased, combined with an average destruction efficiency provided by suppliers. While this approach simplifies calculations, it introduces several limitations, for example, emissions factors often represent average values across different systems and operational conditions, failing to account for site-specific variations. Assumptions about abatement efficiency, gas composition, or operating conditions may not reflect real-world performance, leading to over-or underestimation of emissions. As regulations demand more detailed and documented or verifiable emissions data, relying on broad assumptions can expose organizations to compliance risks. These limitations highlight the need for improved methods of reporting emissions.

In contrast, the bottom-up approach offers a shift in how emissions are calculated and reported. Rather than relying on generalized estimates, this method uses measured, monitored, or inferred operational data associated with semiconductor processing tools and abatement systems to quantify emissions. For example, suppliers can monitor process gas flow rates and operational parameters, (e.g., plasma, combustion, thermal oxidation, etc.), the system's determined destruction efficiency, and the composition of residual gases and byproducts. This data is then aggregated into a comprehensive emissions profile, which is delivered to the user. This method enables emissions reporting that is more accurate and granular. Measurements are based on actual system performance and operational parameters, reducing reliance on assumptions. Data includes detailed information on specific gases, abatement efficiencies, and byproduct generation. Customers can rely on the data as it is derived from monitored operational data rather than estimated from external benchmarks.

Suppliers offering bottom-up emissions reporting establish themselves as transparent and responsible partners in the value chain. By providing users with detailed emissions data, they enable greater accountability and foster trust. This transparency is valuable for users aiming to meet the requirements of frameworks like the Greenhouse Gas Protocol, SBTi, and CDP. It also simplifies reporting for users, as they may reduce the need to extrapolate emissions data based on incomplete or generalized inputs.

The bottom-up approach empowers users to align their operations with sustainability goals. More accurate emissions data allows users to identify emissions hotspots in their supply chain, develop targeted mitigation strategies, such as optimizing gas usage or switching to less impactful materials, and report Scope 1 emissions with improved confidence. Moreover, suppliers who proactively offer detailed emissions data support to their users create a collaborative approach to sustainability. As such, by transitioning from top-down assumptions to bottom-up data-driven reporting, suppliers and users can achieve improved accuracy and transparency in emissions accountability. This approach addresses regulatory and market demands, and paves the way for more sustainable, data-driven business practices that support global climate goals.

Furthermore, the systems and methods described herein improve measurement accuracy by collecting and attributing gas usage, abatement performance, and emissions-related data at the level of individual tools, chambers, process types, and/or process steps. By determining emissions from controller-collected operational data, including measured, monitored, or inferred gas flows, process recipe parameters, determined destruction efficiency, residual emissions, and byproduct formation, the example implementations reduce reliance on generalized facility-wide assumptions and provide a more technically accurate emissions determination for a given industrial process environment.

The example implementations also may reduce latency in emissions reporting by integrating emissions determination directly into a system controller communicating with process tools, abatement systems, and associated networks, rather than depending on manual spreadsheet-based workflows or delayed post-process reconciliation. This direct controller integration improves data integrity by reducing transcription errors, omission of relevant operating parameters, and inconsistencies introduced when data is manually transferred between different systems. In addition, process-specific emissions modeling, such as categorizing gases according to tool type and process type and applying emissions-estimation methodologies at a corresponding level of granularity, reduces computational error compared with approaches that apply undifferentiated facility-level factors across heterogeneous tools and processes. As a result, the example implementations provide a technical improvement in the way industrial emissions data is acquired, processed, and transmitted within a networked manufacturing environment.

Further, in some implementations, the system controller may use determined emissions information as part of a feedback framework for improving abatement performance and overall process operation. For example, emissions values, threshold events, abnormal gas-consumption patterns, drops in destruction efficiency, or changes in byproduct formation may be used to trigger corrective actions, alerts, maintenance events, or operational adjustments to one or more process tools or abatement subsystems. This feedback capability can improve abatement optimization by enabling faster detection of performance degradation and more targeted responses than existing reporting systems that generate periodic summaries for later review. Accordingly, the example subject matter provides technical advantages not only in reporting direct greenhouse-gas emissions, but also in improving the operation, monitoring, and control of industrial processing environments.

While this specification contains many specific implementation details, these should not be construed as limitations on the scope of what may be claimed, but rather as descriptions of features that may be specific to particular implementations. Certain features that are described in this specification in the context of separate implementations may also be implemented, in combination, in a single implementation. Conversely, various features that are described in the context of a single implementation may also be implemented in multiple implementations, separately, or in any suitable sub-combination. Moreover, although previously described features may be described as acting in certain combinations and even initially claimed as such, one or more features from a claimed combination may, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) may be advantageous and performed as deemed appropriate. While the various steps in an embodiment method or process are presented and described sequentially, one of ordinary skill in the art will appreciate that some or all of the steps may be executed in different order, may be combined, or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Furthermore, any claimed implementation is considered to be applicable to at least a computer-implemented method; a non-transitory, computer-readable medium storing computer-readable instructions to perform the computer-implemented method; and a computer system including a computer memory interoperability coupled with a hardware processor configured to perform the computer-implemented method or the instructions stored on the non-transitory, computer-readable medium.

As used herein, “a CPU”, “controller”, “a processor”, “at least one processor”, or “one or more processors”, generally refers to a single processor configured to perform one or multiple operations or multiple processors configured to collectively perform one or more operations. In the case of multiple processors, the one or more operations could be divided amongst different processors, though one processor may perform multiple operations, and multiple processors could collectively perform a single operation. Similarly, “a memory”, “at least one memory”, or “one or more memories”, generally refers to a single memory configured to store data and/or instructions, multiple memories configured to collectively store data and/or instructions.

As used herein, “gas” and “fluid” may be used interchangeable with either term generally referring to elements, compounds, materials, etc., having the properties of a gas, a fluid, or both a gas and a fluid.

Unless defined otherwise, all technical and scientific terms used have the same meaning as commonly understood by one of ordinary skill in the art to which these systems, apparatuses, methods, processes and compositions belong.

In this disclosure, the terms “top”, “bottom”, “side”, “above”, “below”, “up”, “down”, “upward”, “downward,” “horizontal,” “vertical,” and the like do not refer to absolute directions. Instead, these terms refer to directions relative to a nonspecific plane of reference. This non-specific plane of reference may be vertical, horizontal, or other angular orientation.

The singular forms “a”, “an”, and “the”, include plural referents, unless the context clearly dictates otherwise. Within a claim, reference to an element in the singular is not intended to mean “one and only one” unless specifically so stated, but rather “one or more”. Unless specifically stated otherwise, the term “some” refers to one or more.

Embodiments of the present disclosure may suitably “comprise”, “consist”, or “consist essentially of”, the limiting features disclosed, and may be practiced in the absence of a limiting feature not disclosed. As used here and in the appended claims, the words “comprise”, “has”, and “include”, and all grammatical variations thereof are each intended to have an open, non-limiting meaning that does not exclude additional elements or steps.

“Optional” and “optionally” means that the subsequently described material, event, or circumstance may or may not be present or occur. The description includes instances where the material, event, or circumstance occurs and instances where it does not occur.

“Coupled” and “coupling” means that the subsequently described material is connected to previously described material. The connection may be a direct, or indirect connection, and may, or may not, include intermediary components such as plumbing, wiring, fasteners, mechanical power transmission, electrical communication, wired and/or wireless transmission, etc., which may be suitable to affect operation of the components.

As used, the term “determining” encompasses a wide variety of actions. For example, “determining” may include calculating, computing, processing, deriving, investigating, looking up, for example, looking up in a table, a database, or another data structure, and ascertaining. In addition, “determining” may include receiving, for example, receiving information, and accessing, for example, accessing data in a memory. In addition, “determining” may include resolving, selecting, choosing, and establishing.

When the word “approximately” or “about” are used, this term may mean that there may be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. It is the express intention of the applicant not to invoke 35 U.S.C. § 112(f), for any limitations of any of the claims, except for those in which the claim expressly uses the words ‘means for’ together with an associated function.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method for controlling emissions reporting in a processing environment, the method comprising:
receiving, by a system controller from a plurality of processing components, process data associated with operation of one or more semiconductor processing tools and an abatement system coupled to the one or more semiconductor processing tools;
determining, by the system controller from the process data, direct greenhouse-gas emissions associated with the operation of the one or more semiconductor processing tools using measured or monitored operating data of the processing environment;
generating, by the system controller, a report satisfying direct greenhouse-gas emissions reporting requirements based on the determined direct greenhouse-gas emissions; and
transmitting, by the system controller over a network, the report to a remote user system associated with operation of the one or more semiconductor processing tools.

2. The method of claim 1, wherein the process data comprises at least one of process gas flow data, gas composition data, process recipe data, chamber step times, abatement-system operating data, destruction efficiency data, residual gas emissions data, byproduct gas data, emission-factor data, leak-related data, or system diagnostic data.

3. The method of claim 1, wherein determining the direct greenhouse-gas emissions comprises categorizing process gases according to semiconductor tool type and process type prior to determining the direct greenhouse-gas emissions.

4. The method of claim 1, wherein determining the direct greenhouse-gas emissions comprises using a methodology at least as restrictive as Intergovernmental Panel on Climate Change (IPCC) Tier 2b emissions factors or IPCC Tier 2c emissions factors.

5. The method of claim 4, wherein determining the direct greenhouse-gas emissions comprises applying a facility-level emissions-estimation methodology to facility-level gas data and applying a tool-type-level emissions-estimation methodology to tool-type-level gas data.

6. The method of claim 1, wherein determining the direct greenhouse-gas emissions is performed from controller-collected operational data without reliance solely on procurement records for emissions determination.

7. The method of claim 1, wherein determining the direct greenhouse-gas emissions comprises determining residual emissions from process gases remaining after abatement and determining byproduct emissions generated by the abatement system.

8. The method of claim 1, wherein generating the report comprises generating equipment-specific emissions information for at least one semiconductor processing tool, emissions information by gas type, and aggregated carbon-dioxide-equivalent emissions information.

9. The method of claim 1, wherein transmitting the report comprises transmitting the report in real time or near real time or periodic intervals responsive to receipt of the process data.

10. The method of claim 1, wherein transmitting the report comprises transmitting the report in response to a triggering event comprising at least one of an emissions threshold being exceeded, a predicted emissions threshold being exceeded, a drop in abatement efficiency, a detected equipment fault, a detected potential gas leak condition, or a variation in gas flow exceeding a threshold.

11. A system for emissions reporting, comprising:
an abatement system configured to receive exhaust from one or more semiconductor processing tools;
a communication interface configured to receive process data associated with the one or more semiconductor processing tools and the abatement system; and
a system controller comprising one or more processors and a memory storing instructions that, when executed by the one or more processors, cause the system controller to:
receive the process data from the communication interface;
determine direct greenhouse-gas emissions associated with operation of the one or more semiconductor processing tools and the abatement system using measured or monitored operating data;
generate a report satisfying direct greenhouse-gas emissions reporting requirements based on the determined direct greenhouse-gas emissions; and
transmit the report to a remote user system.

12. The system of claim 11, wherein the communication interface is configured to receive the process data from a plurality of sensors comprising at least one of a mass flow controller, a gas flow meter, a gas analyzer, or an exhaust or residual gas sensor.

13. The system of claim 11, wherein the system controller is configured to correlate the process data with at least one of a tool state, process recipe parameter, a chamber step, a process type, or an abatement operating state to determine emissions values for a selected tool, chamber, process step, or reporting interval.

14. The system of claim 11, wherein the system controller is configured to determine the direct greenhouse-gas emissions using a methodology at least as restrictive as Intergovernmental Panel on Climate Change (IPCC) Tier 2b emissions factors or IPCC Tier 2c emissions factors.

15. The system of claim 11, wherein the system controller is configured to determine the direct greenhouse-gas emissions by combining gas-flow data, process-type data, and abatement-performance data to generate tool-specific emissions values.

16. The system of claim 11, wherein the system controller is configured to transmit the report to the remote user system through at least one of a user portal, an application programming interface, a cloud-based reporting platform, or an automated electronic message.

17. The system of claim 11, wherein the system controller is configured to automatically generate and transmit an updated report according to a schedule or in response to a triggering event.

18. A computer-implemented method for controlling operation of a processing environment, the method comprising:
receiving, by a system controller, process data associated with operation of one or more semiconductor processing tools and an abatement system coupled to the one or more semiconductor processing tools;
determining, by the system controller from the process data, direct greenhouse-gas emissions associated with operation of the one or more semiconductor processing tools and the abatement system;
evaluating, by the system controller, the determined direct greenhouse-gas emissions, predicted or estimated direct greenhouse-gas emissions, or abatement efficiency relative to one or more thresholds;
determining, by the system controller, a control action based on the evaluating; and
causing, by the system controller, adjustment of one or more operating parameters of the one or more semiconductor processing tools or the abatement system based on the control action.

19. The method of claim 18, wherein the one or more operating parameters comprise at least one of a gas flow rate, a process recipe parameter, a chamber step duration, a plasma power setting, an abatement power setting, an oxidant flow rate, or an exhaust handling parameter.

20. The method of claim 18, wherein causing adjustment of the one or more operating parameters comprises transmitting a control instruction to the one or more semiconductor processing tools or the abatement system and thereafter monitoring updated operation to determine updated direct greenhouse-gas emissions.
